(19) United States
(12) Patent Application Publication
(10) Pub. No.: US 2015/0240093 A1
(43) Pub. Date: Aug. 27, 2015

(54) Compositions, Systems, Methods and Devices for Utilizing Microorganisms in Print

(71) Applicant: LIVING INK TECHNOLOGIES, LLC, Fort Collins, CO (US)

(72) Inventors: Stevan Craig Albers, Fort Collins, CO (US); Scott Paul Fulbright, Denver, CO (US); Jeffrey Zdunek, Fort Collins, CO (US)

(21) Appl. No.: 14/604,333

(22) Filed: Jan. 23, 2015

Related U.S. Application Data
(60) Provisional application No. 61/943,520, filed on Feb. 24, 2014.

(51) Int. Cl. C09D 11/14; C09D 11/06; C09D 11/02; C09D 11/04

(52) U.S. Cl. CPC C09D 11/14; C09D 11/04; C09D 11/06; C09D 11/02

(57) ABSTRACT

The disclosed apparatus, systems and methods relate to various compositions, systems, methods and devices for producing a cultured, or living ink. The cultured ink utilizes a plurality of microbes which are initially invisible and then become visible over time upon growing on a substrate, such as paper.

### CROSS-REFERENCE TO RELATED APPLICATION(S)

This application claims priority from U.S. Provisional Application 61/943,520, filed Feb. 24, 2014, and entitled “Utilizing Microorganisms as Natural Print, Natural Colors and Coatings for Greeting Cards, Message Delivery, Signs, Toys, Educational Products and Novelty Gifts,” which is hereby incorporated herein by reference in its entirety.

### TECHNICAL FIELD

The disclosure relates to various compositions, systems, devices and methods relating to a cultured ink which can be applied to a substrate. In exemplary embodiments, this cultured ink is initially colorless and becomes visible over a course of time.

### BACKGROUND

The greeting card and educational toy industries are filled with various promotional products, signs, billboards, toys, coloring books and other arts and crafts. These industries are striving to develop products that are innovative, sustainable, interactive, unique and educational.

### BRIEF SUMMARY

Discussed herein are various embodiments relating to the use of microorganisms as a cultured ink which is capable of displaying a message to a reader over time.

Accordingly, one aim of the cultured ink is the use of algae as an ink that is capable of developing in a deliberate time-lapse manner as a form of image or message delivery.

The use of phenolphthalein as a way to “see” the ink in a temporary manner prior to the growth of the algae ink on the substrate. We add phenolphthalein to the algal solution, which makes it red in hue. The user then can see where they are writing on the substrate. Once the substrate is placed on the agar/growth medium, the red color disappears.

In Example 1, a cultured ink comprises a plurality of microbes; a liquid growth media, and a transiently visible compound.

In Example 2, the ink according to Example 1, wherein the plurality of microbes is selected from a group consisting of Synechocystis sp. PCC 6803, Synechococcus sp. PCC 7002, and Haematococcus pluvialis.

In Example 3, the ink of Example 1, wherein the plurality of microbes are present at an OD₇₃₀ of from about 0.01 to about 1000 OD.

In Example 4, the ink of Example 1, wherein the liquid growth solution is TES, BICINE, or HEPES.

In Example 5, the ink of Example 1, further comprising a carbon source selected from a group consisting of sucrose, fructose, glucose, galactose, amino acids, proteins, fats, oils lipids, and carbohydrates.

In Example 6, the ink of Example 1, wherein the transiently visible compound is visible at pH of 8.2 and above and invisible at pH below 8.2.

In Example 7, the ink of Example 6, wherein the transiently visible compound is phenolphthalein, thymolphthalein or cresolphthalein.

In Example 8, the ink of Example 1, wherein the transiently visible compound is selected from a group consisting of ammonia, copper sulfate, lead nitrate, iron sulfate, cobalt chloride, iron sulfide, starch, lemon juice, sodium chloride, and cerium oxalate.

In Example 9, a method of printing with cultured ink comprising providing a ink solution comprising a plurality of microbes, applying the ink solution to a substrate, and providing light and liquid growth media to the substrate so as to develop the ink solution on the substrate over time.

In Example 10, the method of Example 9, wherein the substrate is paper.

In Example 11, the method of Example 9, wherein the substrate is applied to a secondary substrate prior to the application of the ink.

In Example 12, the method of Example 9, wherein the ink is applied to the substrate by way of an applicator.

In Example 13, the method of Example 13 wherein the applicator is selected from the group consisting of a pen, a brush, a printer, and a stylus.

In Example 14, a kit for printing with cultured ink comprising cultured ink components further comprising a plurality of microbes, and a growth media, a growth media frame, and an applicator.

In Example 15, the kit of Example 14, further comprising a transiently visible compound.

In Example 16, the kit of Example 14, further comprising a carbon source.

In Example 17, the kit of Example 14, further comprising a substrate.

In Example 18, the kit of Example 14, further comprising a secondary substrate.

In Example 19, the kit of Example 14, wherein the growth media frame further comprises a reservoir and a substantially translucent lid.

In Example 20, the kit of Example 14, further comprising cultured ink components for a plurality of cultured inks.

While multiple embodiments are disclosed, still other embodiments of the disclosure will become apparent to those skilled in the art from the following detailed description, which shows and describes illustrative embodiments of the disclosed apparatus, systems and methods. As will be realized, the disclosed apparatus, systems and methods are capable of modifications in various obvious aspects, all without departing from the spirit and scope of the disclosure. Accordingly, the drawings and detailed description are to be regarded as illustrative in nature and not restrictive.

### BRIEF DESCRIPTION OF THE DRAWINGS

FIG. 1 is a series of time lapse photographs showing the development of cultured ink over time, according to one embodiment.

FIG. 2 depicts the application of two Synechocystis sp. cultured ink of varying densities on a single agar plate, and illustrates a density dependent growth rate.

FIG. 3A depicts the use of phenolphthalein as a disappearing pink dye in a cultured Synechocystis ink allows the user to paint or write with low densities of algae.

FIG. 3B depicts a further example of the use of phenolphthalein as a disappearing pink dye in a cultured Synechocystis ink allows the user to paint or write with low densities of algae.

FIG. 4 depicts a single plate of various densities of a Synechocystis algae culture throughout the course of 5+ days of growth brushed on 300 g/m² unsized (untreated) paper laid on a single agar plate illustrates a density dependent growth rate.

FIG. 5 depicts a single plate of various densities of a Synechocystis algae culture throughout the course of 5+ days of growth brushed onto 140 g/m² slack-sized (weakly treated) paper laid on a single agar plate illustrates a density dependent growth rate.

FIG. 6 depicts a single plate of various densities of a Synechocystis algae culture throughout the course of 5+ days of growth brushed on 280 g/m² moderately sized (treated) paper laid on a single agar plate illustrates a density dependent growth rate.

FIG. 7A depicts a side view of an exemplary embodiment of the applicator.

FIG. 7B depicts a top view of various aspects of the applicator, according to various embodiments.

FIG. 7C depicts a side view of two applicators according to two exemplary embodiments.

FIG. 8A is a side view of a growth frame, according to an exemplary embodiment.

FIG. 8B is a top view of the embodiment of FIG. 8A.

FIG. 9A is a side view of a growth frame, according to an exemplary embodiment.

FIG. 9B is a front view of the embodiment of FIG. 9A.

### DETAILED DESCRIPTION

The disclosed devices, systems and methods relate generally to the use of biological organisms for creating images on physical media. For brevity, the various modalities described herein may be referred to in reference to the system, methods or devices contemplated by this disclosure, however these references are in no way intended to curtail the extent of the disclosure to a specific modality.

Ranges can be expressed herein as from “about” one particular value, and/or to “about” another particular value. When such a range is expressed, a further aspect includes from the one particular value and/or to the other particular value. Similarly, when values are expressed as approximations, by use of the antecedent “about,” it will be understood that the particular value forms a further aspect. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. It is also understood that each unit between two particular units are also disclosed. For example, if 10 and 15 are disclosed, then 11, 12, 13, and 14 are also disclosed.

In exemplary embodiments, various compositions, devices, systems and methods for a cultured ink are provided. In these various embodiments, a living microorganism is utilized to produce an image on a substrate, such as paper, over a course of time. In certain exemplary embodiments, the image is initially imperceptible, and then becomes visible over time. In further embodiments, an applicator is used. In further embodiments, a “transiently visible compound” is utilized in the composition.

There is a need in the art for using living cells as ink to write, draw, design and paint words and patterns for multiple industries such as, greeting cards, promotional products, signs, billboards, toys, coloring books and other arts and crafts. These industries are striving to develop products that are innovative, sustainable, interactive, unique and educational. This product is innovative because as the ink grows, a time-lapse message forms. The algae is renewable, natural and sustainable as it uses carbon dioxide and light to physically appear. Currently, there are no products in the marketplace that use microorganisms as ink. Further, by combining biology with these products, each product offers and educational component to the user. Greeting cards and educational toy products include do-it-yourself option allowing an interactive experience.

Accordingly, the disclosure relates to using living microorganisms, including microalgae, algae, cyanobacteria, fungi and bacteria cells as an ink, dye, paint or colorant, which begins as invisible and becomes visible over a period of time. These organisms can be employed as colorants for toys, art projects, or educational products, replacing the traditionally utilized paints, dyes, inks, and other colorants or as a new type of “colorant” that is capable of actively growing and changing over time to create time-lapse message communication. The cells are applied to the substrate in which these diverse organisms can use organic carbon based compounds and/or sunlight as energy sources to reproduce quickly. Additionally, substrates that support algae growth on can be placed in a box, plate or bag that can be composed of plastic, paper, cardboard or similar materials. These containers can have aeration by adding strategically placed holes or having completely open sides, or may be completely closed. The natural biodiversity these microorganisms display provides attractive colors, patterns, shadings and textures. These attributes combined with fast cellular reproduction allow them to be grown in controlled ways to create artwork, drawings, backgrounds and writing. Additionally, cells can be placed in a pen like container in which the cells are exuded out the end of the pen onto a suitable substrate. Natural light sources and/or artificial light sources may be used as energy sources for mixotrophic and autotrophic organisms. Organic carbon sources can be added to the matrix as an energy source for use by mixotrophic and heterotrophic organisms. Microorganisms can be used as natural products in the place of inks, paints and other pigments. A single product may include a one or multiple species of organisms to add variety.

### Cultured Ink

In one aspect, disclosed is a cultured ink comprising a plurality of microbes, a growth media and a transiently visible compound.

### Plurality of Microbes

In one aspect, the disclosed ink is comprised of a plurality of microbes. As used herein, “plurality of microbes” means a population of microorganisms, that are visible, or become visible, when applied to a substrate through the methods disclosed herein. In certain aspects, the plurality of microbes are from a single species. In further aspects, the plurality of microbes comprise two or more species. According to certain embodiments, the plurality of microbes are single celled organisms. In further embodiments, the plurality of microbes are colony forming organisms. In certain aspects, the plurality of microbes are capable of photoautotrophic growth. In further aspects, the plurality of microbes are capable of mixotrophic growth. In still further aspects, the plurality of microbes are capable of heterotrophic growth. In preferred embodiments, the plurality microbes have some or all of the following characteristics: capability of growing in different intensities of light, tolerance to various concentrations of salt, and capability of growing in various levels of hydration.

According to certain embodiments, the plurality of microbes may be selected from a group consisting of Synechocystis PCC 6803, Synechococcus PCC 6717, Synechococcus PCC 6301, Synechococcus IU 625, Synechococcus PCC 6312 Synechococcus elongatus PCC 7942, Nostoc sp., Synechococcus 6911, Synechococcus leopoliensis, plankthorax rubescens, Synechococcus PCC 7002, Arthospira platensis PCC 7345, Haematococcus pluvailis, Navicula pelliculosa, Cryptomonas erosa, Rhodomonas minuta, Porphyridium purpureum, Phaeodactylum tricornutum, Nannochloropsis sp. Synechocystis sp., Synechococcus sp., Nostoc sp., plankthorax sp., Arthospira sp., Haematococcus sp., Navicula sp., Cryptomonas sp. Rhodomonas sp. Porphyridium sp., Phaeodactylum sp., Nannochloropsis sp., Volvox sp., Anabena sp., Chlorella sp., Euglena sp., Achnantes sp., Botryococcus sp., Chaetoceros sp., Chroococcus sp., Cosmarium sp., Microcystis sp., Microspora sp., Pediastrum sp., Scenedesmus sp., Spirogyra sp., Spirulina sp., Zygnema sp., Chlorobium sp., Escherichia sp., Spirillum sp., Chromobacterium sp., Janthinobacterium sp., Streptomyces sp., Xanthomonas sp., Sarcina sp., Serratia sp., Rhizobium sp., Prevotela sp., Actinomyces sp., Staphylococcus sp., Proteus sp., Micrococus sp., Rugamonas sp., Pseudomonas sp., Helicobacter sp., Saccharomyces sp., Candida sp., Leucosporidium sp., Rhodotorula sp., Schizosaccharomyces sp., Dekker sp., Brettanomyces sp., Synechocystis sp., Synechococcus sp., Nostoc sp., plankthorax sp., Arthospira sp., Haematococcus sp., Navicula sp., Cryptomonas sp. Rhodomonas sp. Porphyridium sp., Phaeodactylum sp., Nannochloropsis sp., Volvox sp., Anabena sp., Chlorella sp., Euglena sp., Achnantes sp., Botryococcus sp., Chaetoceros sp., Chroococcus sp., Cosmarium sp., Microcystis sp., Microspora sp., Pediastrum sp., Scenedesmus sp., Spirogyra sp., Spirulina sp., Zygnema sp., Chlorobium sp., Escherichia sp., Spirillum sp., Chromobacterium sp., Janthinobacterium sp., Streptomyces sp., Xanthomonas sp., Sarcina sp., Serratia sp., Rhizobium sp., Prevotela sp., Actinomyces sp., Staphylococcus sp., Proteus sp., Micrococus sp., Rugamonas sp., Pseudomonas sp., Helicobacter sp., Saccharomyces sp., Candida sp., Leucosporidium sp., Rhodotorula sp., Schizosaccharomyces sp., Dekker sp., or Brettanomyces sp. One skilled in the art will appreciate that other microbes are possible.

In certain aspects, the microbe or microbes are selected for its aesthetic properties once the ink has been applied to a substrate. Examples of such properties include, but are not limited color, ink spread, and intensity. For example, alga Synechococcus sp. can be used to achieve a green color, while can Haematococcus be used to achieve a red color. Further non-limiting examples are set forth in Table 1.

TABLE 1

| Green | Blue-green | Black | Pink/Red/purple/brown |
|---|---|---|---|
| Synechocystis | Synechococcus | Phormidium | Fremyella diplosiphon |
| sp. PCC 6803 | leopoliensis | inundatum | |
| Synechococcus | | Phormidium | Phormidium persicinum |
| sp. PCC 7002 | | luridum | |
| Volvox | | | Haematococcus pluvialis |
| globator | | | |
| Chlorella sp. | | | Planktothrix rubescens |
| | | | Navicula pelliculosa |
| | | | Phaeodactylum |
| | | | tricornutum |
| | | | Cryptomonas erosa |
| | | | Porphyridium |
| | | | purpureum |
| | | | Rhodomonas minuta |
| | | | Rhodosorus sp. |

According to certain embodiments, the plurality of microbes can be cultured in the disclosed growth media to various concentrations. It is understood that the aesthetic properties of ink once applied to the substrate and development time vary according to the microbial concentration used. According to certain embodiments, the plurality of microbes may be cultured at a density from about 0.001 OD₇₃₀ to about 1000 OD₇₃₀ In certain aspects, microbial culture density determines the latency for cultured ink to become visible after application to a substrate. According to certain embodiments, cultured ink with a microbial with a density of about 0.001 OD₇₃₀ becomes visible in less than 1 month. Cultures with a density of above about 2.5 OD₇₃₀ can be immediately seen on the substrate, while OD's of up to 1000 OD₇₃₀ can be used as ink. According to further embodiments, preferred concentrations are between about 0.01 OD₇₃₀ and about 10 OD₇₃₀.

According to certain embodiments, the provided plurality of microbes are present various stages of growth, such as lag phase, exponential growth phase, or stationary phase and can be used to vary the beginning rate of growth of the cultures. Cells grown in a batch growth system (wherein all nutrients are added at the beginning of the cycle and no further nutrients or any other growth solution are added) isolated during lag or stationary phase of growth will grow at slower doubling times than a culture isolated during exponential growth phase. Cells in batch culture collected at OD₇₃₀ at low cellular densities (˜OD₇₃₀ of 0.2 and below) are considered to be in lag phase, while cells at very high densities (˜OD₇₃₀ of 10 and above) are considered to be in late log to stationary growth phase. Cells found in the interim ODs can be considered to be in Log growth phase.

### Liquid Growth Media

In certain aspects the cultured ink disclosed herein comprises liquid growth media. Liquid growth media may comprise various essential micronutrients and other components necessary to support growth of the photosynthetic microbes. According to certain embodiments the composition of the liquid growth media will depend upon the particular photosynthetic microbe present in the ink. In further embodiments, the liquid growth media is BG-11, A+ media, OHM, BBM, Chu, or f/2. In further embodiments, the photosynthetic microbe selected is paired with a liquid growth media according to the pairings shown in Table 2. Further, the composition of the growth media may be adjusted so as to

According to certain embodiments, liquid growth media is selected from a group consisting of optimal haematococcus medium, Luria-Bertani, Aiba and Ogawa (AO) Medium, Allen Medium, Allen and Arnon Medium plus Nitrate: ATCC Medium 1142, Antia's (ANT) Medium, Aquil Medium, Ashbey's Nitrogen-free Agar, ASN-III Medium, ASNIII+Turks Island Salts: CRBIP Medium 1538, ASP 2 Medium, ASW Medium: Artificial Seawater and derivatives, ATCC Medium 617: BG-11 for Marine Blue-Green Algae; Modified ATCC Medium 616 [BG-11 medium], ATCC Medium 819: Blue-green Nitrogen-fixing Medium; ATCC Medium 616 [BG-11 medium] without NO3, ATCC Medium 854: ATCC Medium 616 [BG-11 medium] with Vitamin B12, ATCC Medium 1047: ATCC Medium 957 [MN marine medium] with Vitamin B12, ATCC Medium 1077: Nitrogen-fixing marine medium; ATCC Medium 957 [MN marine medium] without NO3, ATCC Medium 1234: BG-11 Uracil medium; ATCC Medium 616 [BG-11 medium] with uracil, Beggiatoa Medium: ATCC Medium 138, Beggiatoa Medium 2: ATCC Medium 1193, Blue-Green (BG) Medium, BG-11 Medium for Blue Green Algae: ATCC Medium 616, BG11+ASNIII (10%): CRBIP Medium 1540, BG11+ASNIII (1:1): CRBIP Medium 1546, BG11+NaHCO3: CRBIP Medium 1547, BG11+Turks Island Salts (25%)+NaHCO3: CRBIP Medium 1548, Bold's Basal (BB) Medium, Bold 1NV Medium, Bold 3N Medium, Bristol Medium, Castenholtz D Medium, Castenholtz D Medium Modified: Halophilic cyanobacteria, Castenholtz DG Medium, Castenholtz DGN Medium, Castenholtz ND Medium, Chloroflexus Broth, Chloroflexus Medium: ATCC Medium 920, Chu's #10 Medium: ATCC Medium 341, Chu's #10 Medium Modified, Chu's #11 Medium Modified, COMBO Medium Modified, CR1 Soil, Cyanophacyean Medium, DCM Medium, DYIV Medium, E27 Medium, E31 Medium and Derivatives, Erd-Schreiber 2X Medium, f/2 Medium, f/2 Medium Derivatives, Fraquil Medium: Freshwater Trace Metal-Buffered Medium, Gorham's Medium for Algae: ATCC Medium 625, h/2 Medium, Jansen's (J) Medium, Jaworski's (JM) Medium, K Medium, L1 Medium and Derivatives, MN Marine Medium: ATCC Medium 957, Plymouth Erdschreiber (PE) Medium, Prochlorococcus PC Medium, Prochlorococcus Medium: CRBIP Medium 1559, Pro99 Medium, Proteose Peptone (PP) Medium, Prov Medium, Prov Medium Derivatives, S77 plus Vitamins Medium, S88 plus Vitamins Medium, Saltwater Nutrient Agar (SNA) Medium and Derivatives, SES Medium, SN Medium, Modified SN Medium, SNAX Medium, Soil/Water Biphasic (S/W) Medium and Derivatives, SOT Medium for Spirulina: ATCC Medium 1679, Spirulina (SP) Medium, van Rijn and Cohen (RC) Medium, Walsby's Medium, YBC-II Medium, Yopp Medium, Z8 Medium, PDA media, YMEA media, Sabouraud Dextrose media, Minimal medium for Aspergillus, Yeast powder soluble starch Agar, Soil Extract Agar, Rose Bengal Agar, Czapek's Agar, or Spezieller Nährstoffarmer agar.

### Carbon Source

In certain aspects, the disclosed cultured ink further comprises a carbon source. The carbon source augments atmospheric CO₂ to support growth of the plurality of microbes in the ink. Specific microorganisms are capable of utilizing sunlight as well as chemical carbon sources as a source of energy. These types of organisms are called mixotrophic organisms. The addition of an alternative carbon source allows for cells to increase their growth rate above that of organisms solely grown in media lacking an alternative carbon source. Exemplary carbon sources include but are not limited to sucrose, fructose, glucose, galactose, amino acids, proteins, fats, oils lipids, or any variety of carbohydrates. An additional carbon source can be added to either the agar growth solution or the liquid growth solution.

### Transiently Visible Compound

In one aspect, the cultured ink disclosed herein comprises a transiently visible compound. According to certain embodiments, the plurality of microbes are present at densities below the threshold of immediate visibility when applied to a substrate, but only become visible after subsequent growth. In certain aspects the transiently visible compound is visible immediately upon application of the cultured ink to the substrate, but no longer visible after a short post-application duration. Accordingly, transiently visible compound serves as a guide to aid the user in the printing process without effecting the final visual effect of the cultured ink. In certain aspects the transiently visible compound is a pH indicator. For example, the cultured ink may include a transiently visible compound wherein the transiently visible compound is visible at pH of 8.3 and above and invisible at pH below 8.2. In further embodiments, the transiently visible compound is phenolphthalein. In further embodiments, other pH indicators such as thymolphthalein, cresolphthalein and the like can be used. In further embodiments, the transiently visible compound may function independent of pH and be, for example, ammonia, copper sulfate, lead nitrate, iron sulfate, cobalt chloride, iron sulfide, starch, lemon juice, sodium chloride, or cerium oxalate.

### Methods of Applying Cultured Ink

Disclosed herein is a method of printing with cultured ink comprising combining a plurality of microbes; liquid growth media; and a transiently visible compound, to form a cultured ink; applying the cultured ink to a substrate; providing light to the substrate to develop the ink.

### Substrate

The plurality of microbes comprising the cultured ink disclosed herein can grow on a wide array of substrates capable of providing a suitable structure and/or essential cellular requirements to the target organisms. These substrates are made from products that can be a liquid, semi-solid, gel like, solid or any combination thereof and may exist exclusively or imbedded within a fibrous matrix. These fibrous matrices can be materials such as or similar to canvas, burlap, cheesecloth and cotton, paper, and other cellulose based materials. Substrates can be made from a variety of starting materials. In certain aspects, substrates are made from materials selected from a group consisting of: cellulose fiber, cotton fiber, silk fibers, phragmite fibers, bamboo fibers, abaca fibers, flax fibers, kozo fibers, wheat fibers, sisal fibers, rice fibers, hemp fibers, rattan fibers, or linen fibers.

According to certain embodiments, the substrate is a paper substrate. Paper stock or paper-like material can be used to support the growth of plurality of microbes within the cultured ink, once they are applied to the substrate. According to certain embodiments, the paper provided has a density from about 75 to about 700 g/m². In certain aspects, the paper is acid free paper. In further aspects, hot or cold press finish papers can be used. A paper substrate can include but is not limited to the following: woodpulp-derived paper, cellulose-derived paper, cotton fiber-derived paper, print-making paper, watercolor paper, rag-paper, news-print paper, card-stock paper, burlap-derived paper. Sizing of the paper is important to the ability for the microbial solutions to grow and spread on the desired substrate. Sizing is a process that changes the absorbtive attributes of the paper through treatment with different substances. The more sizing on a paper, the less absorbtive the paper is. Papers made with no sizing absorb the most moisture from the agar/growth solution as well as absorb the most ink before the liquid in the ink evaporates. Additionally, paper substrates with no sizing also allow the algae ink to “bleed” outside of the applied locations of the ink. This, in some instances, is beneficial, as bleeding can add an artistic touch to the process. This phenomenon allows for “fuzzy” writing, or text that actually grows into locations on the substrate that the applicator didn't apply ink to. Bleeding only occurrs after several days of growth on the paper. As sizing increases to slack sized or weakly sized levels within the substrate, ink growth only occurs in the regions where the ink was originally applied. This growth occurs at rates that are slower than with paper with similar attributes, but with no sizing. Substrates that have levels of sizing above unsized (water-leaf) or weak sized (slack sized) have a difficult time supporting growth of the algae.

### Secondary Substrate

In certain aspects, a secondary substrate is provided. In one aspect the secondary substrate is an agar based substrate. In certain aspects, the secondary agar based substrate further comprises growth media components. The provided growth media components may be comprised of any of growth medias disclosed herein. In an aspect, the substrate can be place upon on the secondary substrate, such that the secondary substrate provides moisture and nutrients to the plurality of microbes from the cultured ink as they grow on the substrate.

### Applying Ink

In certain aspects, the method disclosed herein comprises applying cultured ink to a substrate. In an aspect, applying the ink may be achieved by numerous methods including but not limited to streaking, rubbing, painting, stamping, spotting, spraying, and needle and/or ballistic injection. As will be appreciated by one skilled in the art, the method by which ink is applied to the substrate will affect the appearance of the final image, after the ink has developed.

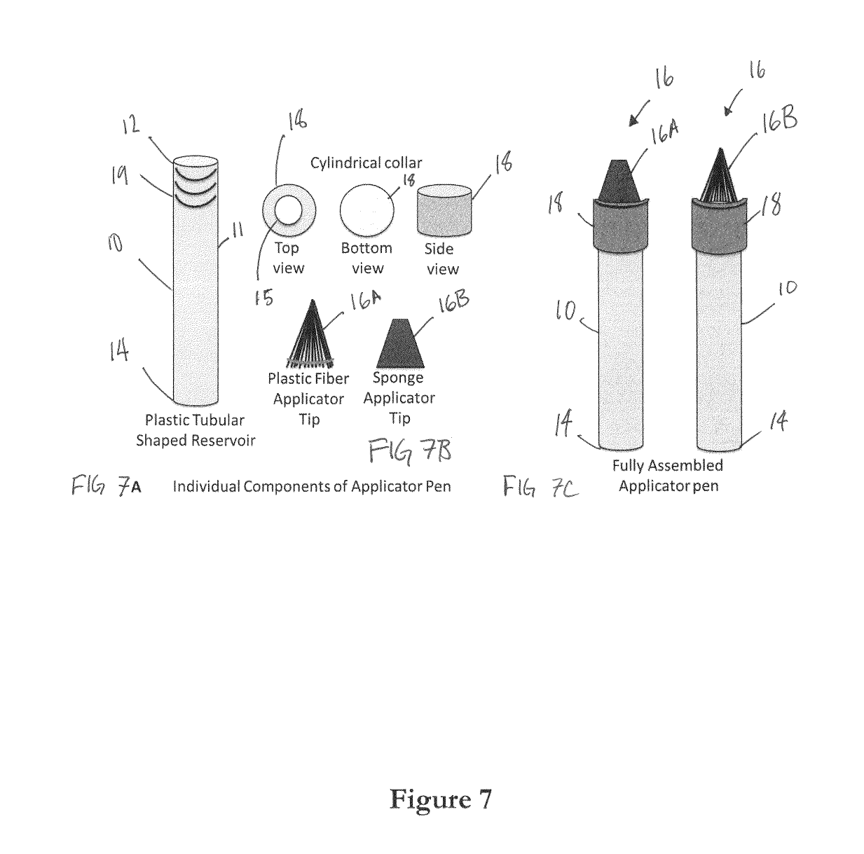

In certain aspects, ink is applied to the substrate by way of and applicator. In certain aspects, the method disclosed herein comprises applying ink to a substrate by way of an applicator where the applicator is a pen, as is described herein in relation to FIGS. 7A-7C.

In certain aspects, the method disclosed herein comprises applying ink to a substrate by way of an applicator where the applicator is an automated machine capable of distributing of solutions of algae across a template. In certain embodiments, this may be a conventional printer or a 3D printer.

### Providing Light to Develop the Ink

In certain aspects, the disclosed method comprises providing light to the substrate to develop the ink. According to certain embodiments, the light provided is natural light (e.g. sunlight). In further embodiments, the light provided is artificial light. In certain embodiments, light provided is provided at wavelength ranging from 400-700 nanometers. In further embodiments, light is provided at a plurality of wavelengths within the range of about 400 to about 700 nanometers. In certain alternative embodiments, light is not essential to the development of the ink, as would be dictated by the biology of the underlying microbes.

According to certain embodiments, light is provided for a period of 2 hours per day. According to further embodiments, light is provided for 24 hours per day. In still further embodiments, light is provided for period of time between about 2 hours per day to about 24 hours of day. According to still further embodiments, the amount of light provided is tailored by the user to determine the rate of cultured ink development desired, with longer light exposures yielding faster development rates. One skilled in the art will appreciate that light intensity and wavelength will affect the amount of light exposure required to achieve a given development rate.

### Plurality of Cultured Inks

In certain aspects, the cultured ink system and method further comprises forming a plurality of cultured inks. In certain aspects, these plurality of cultured inks can be comprised of differing concentrations of microbes, or differing types of microbes, so as to provide a user with a variety of ink options, such as having the ability for the ink to appear at different times, or be various colors.

In certain aspects, the method provided is used to create a time lapse effect of the appearance of the ink design on the substrate. In certain aspects, the method comprises applying a plurality of cultured inks to a substrate, with one or more of the plurality of cultured inks having a distinct characteristics from the other cultured inks provided. In certain aspects, the distinct characteristic is a characteristic of the plurality of microbes. Variable characteristics of the plurality of microbes include, but are not limited to: culture densities, microbial coloration, growth rate, microbial size, light, tolerance to various concentrations of salt, hydration requirement, and nutrient tolerances.

To control the time-lapse effect, multiple varieties of microorganisms can be utilized in the technology in because specific varieties have different growth rates. To use specific types of microorganisms, the same protocol can be utilized with the same potential effect. Variation in the type of microbial population used allows the user to change the rate of appearance on the substrate, thus giving the user the capability of changing how a message appears.

### Kit

In certain aspects, disclosed is a kit for applying cultured ink comprising unmixed cultured ink components comprising a plurality of microbes, a growth media, and a transiently visible compound; growth media substrate components. In further embodiments, the kit comprises a carbon source. In yet further embodiments, the kit comprises a plurality of cultured inks, each comprising a plurality of microbes at varying concentrations so as to provide the user with a variety of time-lapse inks.

### Unmixed Cultured Ink Components

In certain aspects, provided is a kit for printing with cultured ink comprising unmixed ink components. According to certain embodiments, unmixed ink components comprise dried forms of growth media and agar solutions. These solutions can be individually pre-packaged so that upon receiving the kit, the end-user adds a pre-determined amount of water, heats the solution to boiling and pours the dissolved growth media and agar solution into the provided growth chamber. Unmixed ink components may further comprise dried dormant microbes in powder form. Dried growth media is also provided in separate packaging according to certain embodiments. The user adds a specified amount of water to the dried microbes/growth solution. Once the liquid is added, the end-user then adds the applicator tip directly to the microbe/growth solution container and the solution is ready for use. In certain aspects, the kit disclosed herein further comprises instructions for end-user mixing of cultured ink components.

### Substrate

In one aspect, the kit disclosed herein further comprises a substrate for ink application. Suitable substrates can be any substrates disclosed herein. According to certain embodiments, sterile pieces of paper are provided that are individually pre-packaged.

### Growth Media Frame

In one aspect, the kit disclosed herein further comprises a growth media frame. In certain aspects, the growth media frame further comprises a reservoir. In further aspects, the growth media frame further comprises a substantially translucent lid.

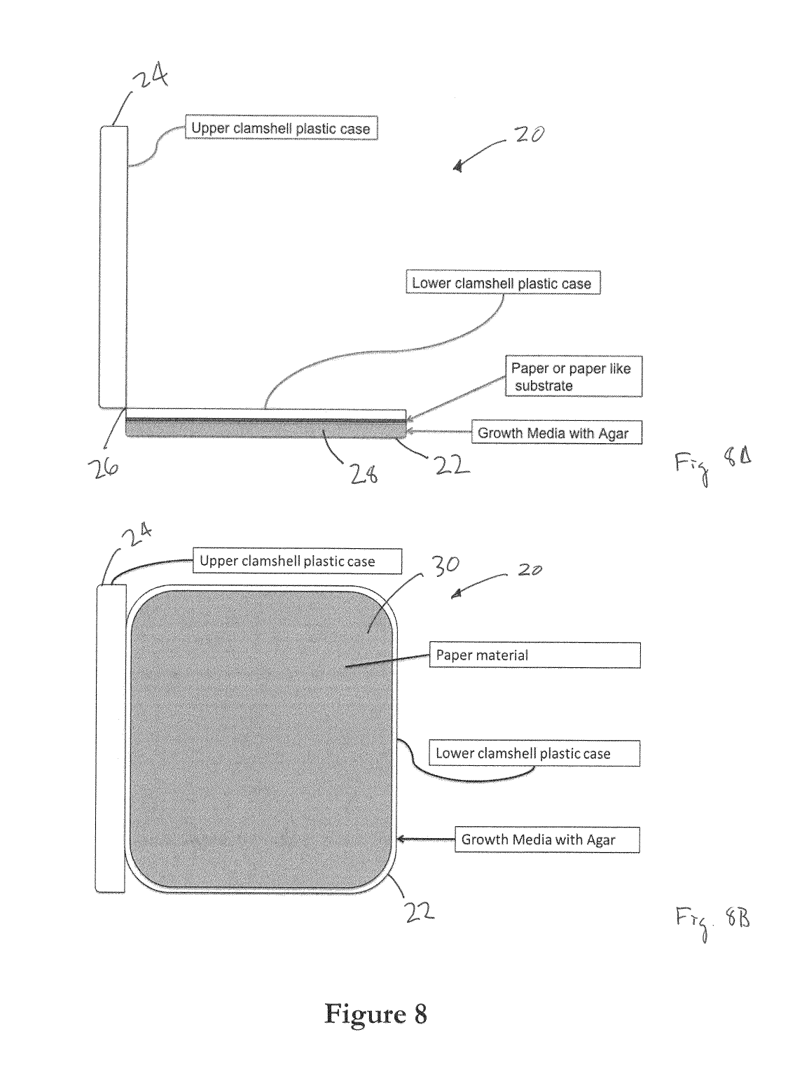

In certain embodiments, the disclosed system and methods comprise a growth chamber, or media frame, which can also be referred to as a “pad”. In certain embodiments, as best shown in FIGS. 8A &8B, the drawing pad comprises a base and lid. In further embodiments, the lid is pivotally attached to the base 22 by way of a hinge so as to take a clamshell configuration. Other embodiments are possible. In certain embodiments, liquid agar-based growth media is poured and cooled in the base of the drawing pad. Once the growth media is cooled and solidified, a paper or paper like substrate is laid directly on the top of the cooled growth media. The user then utilizes an applicator to paint various concentrations of photosynthetic microbes onto the paper or paper-like substrate 30. Over time, the images become apparent to reveal the image, writing or other communication placed on the substrate. Once the image, writing or other communication has grown and all moisture has evaporated from the growth media, the user then removes the paper and can deliver card to the appropriate recipient.

### Applicator

In certain aspects, the kit comprises an ink applicator. In these embodiments, the applicator can comprise a pen, brush, or other writing utensil.

### Exemplary Embodiments

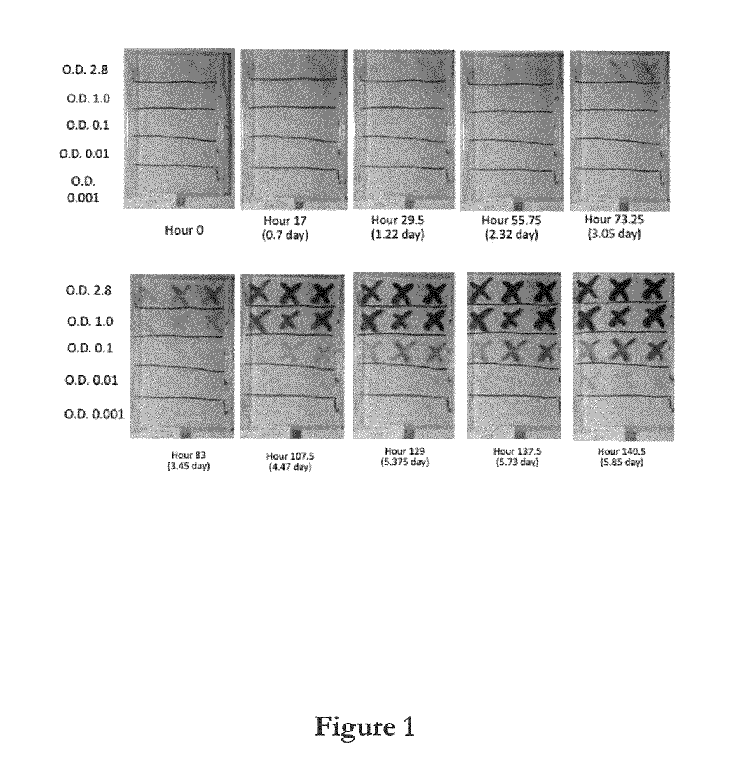

FIG. 1 depicts exemplary embodiments of the cultured ink, wherein Synechocystis is grown directly on agar/growth solution to establish that various concentrations of algae materialize at various rates. These figures depict a dilution series of Synechocystis sp. ink on a single agar plate illustrates a density dependent growth rate. The density of a Synechocystis sp. ink culture was measured with a CARY-UV Spectrophotometer at 730 nm and determined to be at an optical density (OD₇₃₀) of 2.8. The culture was diluted to an OD730 of 1.0, 0.1, 0.01, and 0.001. The undiluted and diluted cultures were brushed onto an agar plate in containing 1% agarose, 1X BG-11 freshwater algae media, 19 mM Sodium Thiosulfate, and 10 mM TES buffer. Densities of the cultured ink are indicated on the left of each row. Each ink culture was brushed into rows of biological triplicates. Rows are delinated by black lines made on the plate. The plate was placed under ˜50 mE of continuous light at room temperature for approximately 5 days. Pictures were taken at various times noted beneath each image.

Additionally, since different varieties of microbes have different phenotypic characteristics, other physical characteristics of the ink can be controlled. For example, alga Synechococcus sp. is green, while Haematococcus is red. In order to use some algae varieties, modifications to the growth media must be made, as shown for example in Table 2.

Table 2 describes the types of media solutions required to grow a selected list of photosynthetic microorganisms capable of being used in the described applications.

TABLE 2
ALGAL GROWTH CONDITIONS

| Media | |
|---|---|
| Type | Microorganisms |
| BG-11 | Synechocystis PCC 6803, Synechococcus PCC 6717, |
| | Synechococcus PCC 6301, Synechococcus IU 625, |
| | Synechococcus PCC 6312 Synechococcus elongatus |
| | PCC 7942, Nostoc sp., Synechococcus 6911, |
| | Synechococcus leopoliensis, plankthorax rubescens |
| A+ | Synechococcus PCC 7002, Arthospira platensis PCC |
| media | 7345 |
| OHM, | Haematococcus pluvailis, Navicula pelliculosa, |
| BBM, | Cryptomonas erosa, Rhodomonas minuta, |
| Chu | |
| f/2 | Porphyridium purpureum, Phaeodactylum |
| | tricornutum, Nannochloropsis sp |

Actively growing or dormant cells can be added to the reservoir. Actively growing cells are directly added to the reservoir along with the appropriate growth solution for the population of microbe in question, as is taught for example in Table 2. Additionally, dormant cells may be added in powder form along with a powder form of the growth media. This dry formulation can remain inactive for weeks to months until water is added to the formulation. Once water is added to the formulation, the reservoir is assembled and is ready for use. In another embodiment, dormant cells can be added directly to a dry sheet of suitable paper. This formulation of dormant cells on specific substrates allows for a longer shelf-life in which the product can go without moisture for a longer period time when compared to the use of actively growing cells.

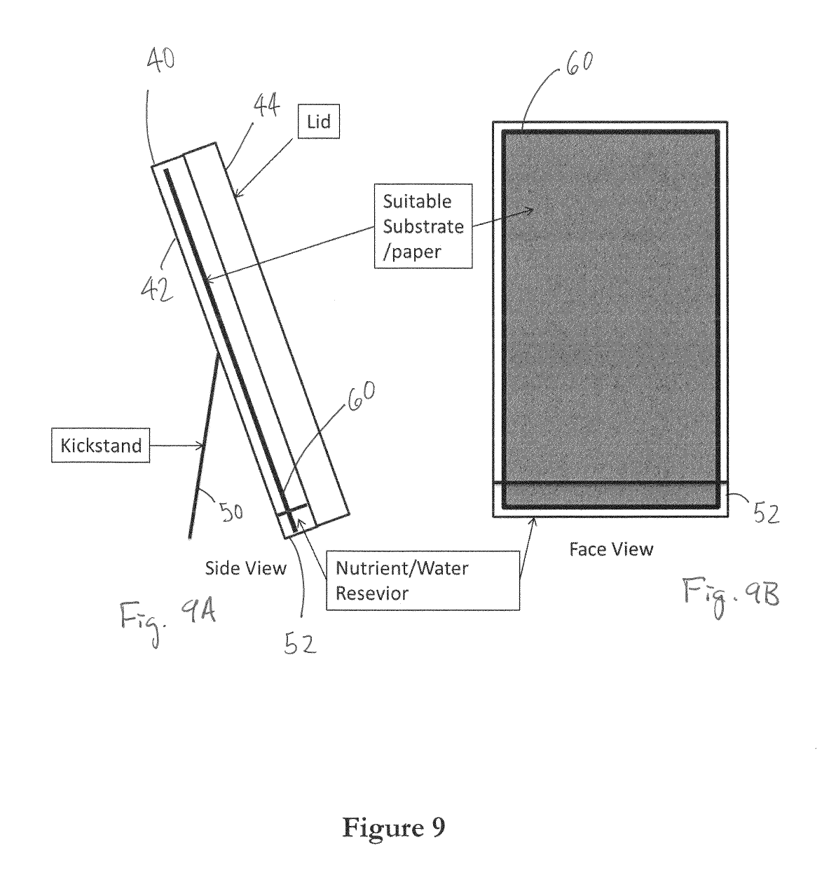

The dormant cells will be in powder form and will be applied in this state directly to the substrate via spraying, painting, rolling, or other applicable methods. The use of various concentrations of dormant cells allows the user to dictate the rate at which different parts of the message become visible over time. To activate the dormant cells, the end user uses a spray bottle or mister filled with the appropriate liquid growth media for the organism in question and sprays the sheet of paper daily. This provides specific micronutrients and water to the cells while allowing them to begin active growth on the substrate. As an alternative mechanism to deliver specific micronutrients and water to the cells, the user props the substrate with dormant cells in a shallow tray filled with micronutrients and water (as described in relation to FIGS. 8-9). In these embodiments, the micronutrients and water are capable of being wicked up the paper, and thus are brought into contact with the dormant cells. This process breaks dormancy and allows for active growth of the applied cells.

In certain embodiments, various stages of growth, such as lag phase, exponential growth phase, or stationary phase can be used to vary the beginning rate of growth of the cultures. Cells grown in a batch growth system (wherein all nutrients are added at the beginning of the cycle and no further nutrients or any other growth solution are added) isolated during lag or stationary phase of growth will grow at slower doubling times than a culture isolated during exponential growth phase. Cells in batch culture collected at OD₇₃₀ at low cellular densities (˜OD₇₃₀ of 0.2 and below) are considered to be in lag phase, while cells at very high densities (˜OD₇₃₀ of 10 and above) are considered to be in late log to stationary growth phase. Cells found in the interim ODs can be considered to be in Log growth phase.

Agar media can be amended with various types of growth solutions capable of supporting microbial cell growth. For example, agar concentrations of anywhere between 0.5%-4% wt/vol is added to the selected growth solution appropriate for the group of microbes to be grown (for examples, see Table 2). The agar/growth solution is then boiled for ˜5 minutes at a minimum and then cooled. This process allows for the agar/growth solution to form a gel matrix that conforms to any container to which it's poured into. Additionally, acid/base buffers are added to the agar/growth solution prior to cooling so to control the overall long-term pH of the growth solution. This control of pH is critical to the characteristic growth of the microbial populations placed on the agar/growth solution. The pH of the agar is also critical to the disappearing pink phenolphthalein solution. The phenolphthalein solution is a pink color at a pH of 8.3 and above but turns colorless once it drops below 8.3. A 1 Molar TES solution adjusted to a pH of 8.0 is used to buffer the agar/growth solution. The final concentration of the TES solution in the agar/growth solution is 10 mM TES. Additionally, a molecule that enhances photosynthetic microbial growth, Sodium Thiosulfate, is added to the agar/growth solution prior to cooling. The final concentration of the Sodium Thiosulfate is 20 mM Sodium Thiosulfate. This heated mixture of agar/growth solution with TES and Sodium Thiosulfate is then poured into a suitable container, preferably made of optically clear plastic, that includes an appropriate optically clear lid. Once the agar/growth solution is cooled, the microbial cell populations can be placed directly on the agar/growth solution at various concentrations and will grow and become visible to the naked eye at various different rates, as seen below in the images/charts discussed.

### Example 1

### Demonstration of Time Lapse

Exemplary embodiments of cultured ink are capable of becoming visable over a course of time. In these embodiments, the user is initially unable to see the image on the substrate, but it becomes visible over time.

FIG. 1 depicts a single plate of various densities of a Synechocystis algae culture throughout the course of 5+ days of growth, as described above. Cultures are grown directly on agar/growth solution. Rows are delinated by black lines made on the plate, with the initial densities of the cultures being recorded as the row legend. Each density is represented in triplicate biological replicates. These cultures were grown are under ˜50 mE of continuous light at room temperature.

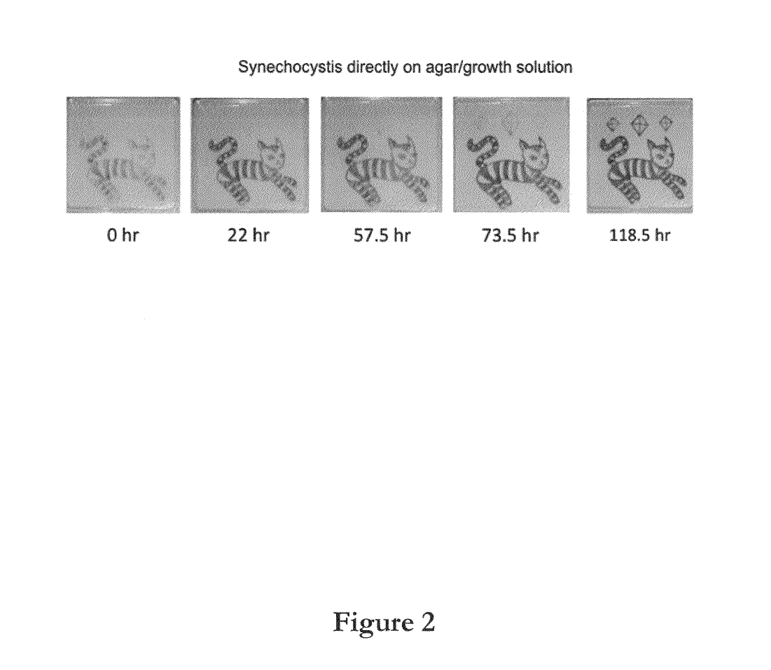

FIG. 2 depicts the application of two Synechocystis sp. cultured ink of varying densities on a single agar plate, and illustrates a density dependent growth rate. Each panel represents an image of the same agar plate over the course of the experiment. The density of a Synechocystis sp. ink culture was measured with a CARY-UV Spectrophotometer at 730 nm and then diluted to an OD₇₃₀ of 5.0 and 1.0. The ink culture with an OD₇₃₀ of 5.0 was brushed onto the agar to create an image of a cat. The ink culture with an OD₇₃₀ of 1.0 was brushed onto the agar to create images of diamonds above the cat. The plate was placed under ˜50 mE of continuous light at room temperature for 118.5 hours. Pictures were taken at various times noted beneath each image.

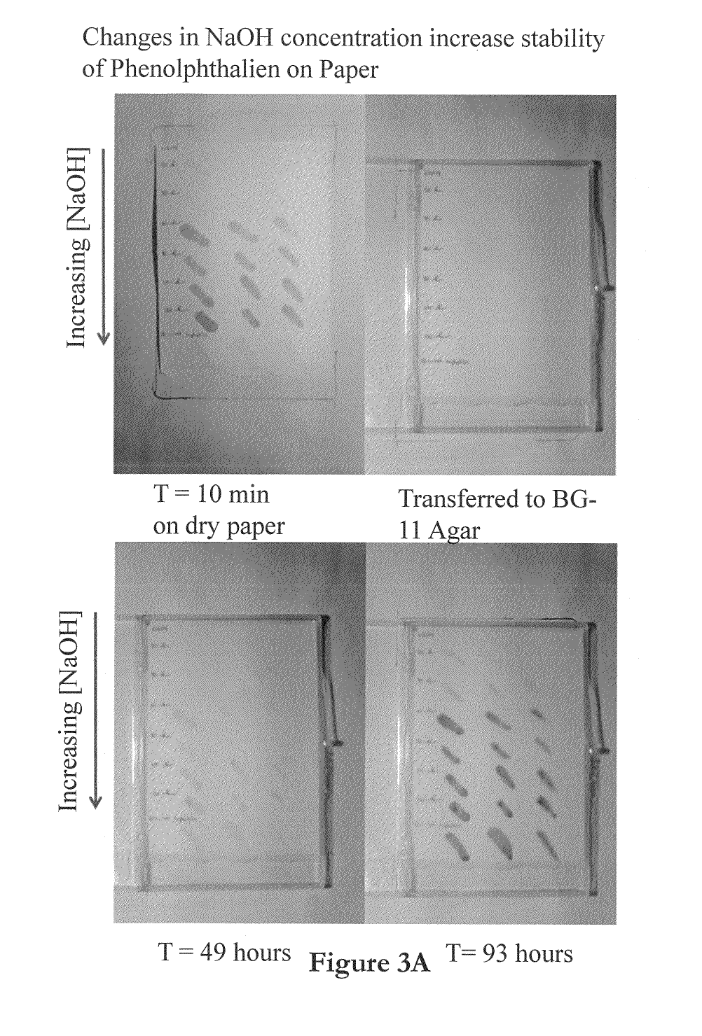

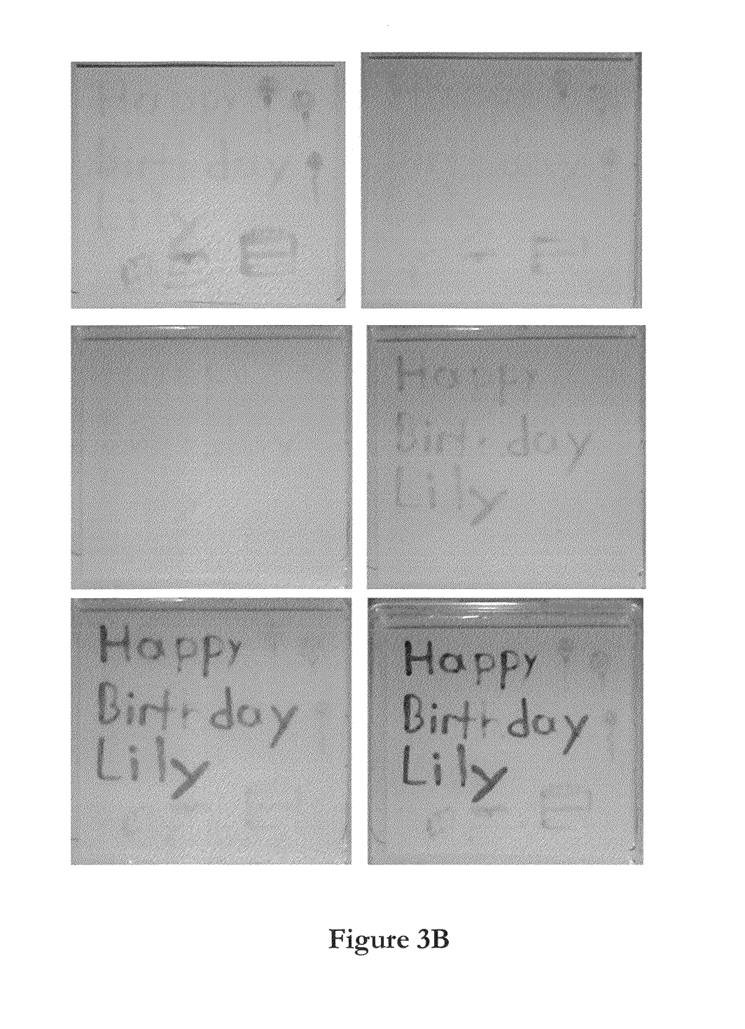

FIG. 3A depicts the use of phenolphthalein as a disappearing pink dye in a cultured Synechocystis ink allows the user to paint or write with low densities of algae. Each panel depicts an image of a single piece 300 g/m² unsized printmaking paper at various time points. The paper is organized into six rows, each an increase in concentration of NaOH in the phenolphthalein solution. Concentrations for the rows are as follows: First row (20 μl 3M NaOH addition) 60 uM, second row (40 μl addition) 90 μM, third row (60 μl addition) 120 μM, fourth row (80 μaddition) 150 μM, fifth row (100 μl addition) 180 μM, sixth row (120 μl addition) 210 μM. The seventh row is a positive control containing only Synechocystis culture (no phenolphthalein) at an OD₇₃₀ of 1.0. A Synechocystis culture was spun down at 4000 RPM for five minutes and resuspended in 1X BG-11 media buffered with 20 mM bicine and then combined with each of the phenolphthalein solutions for a final concentration of 3.1 mM with and a final OD₇₃₀ of 1.0. Each of these cultured inks were brushed upon the paper in triplicate. After 10 minutes, the paper was transferred to an agar plate and placed under ˜50 mE of continuous light at room temperature for 93 hours. Pictures were taken at various times noted beneath each image. The top left panel shows the cultured ink on dry paper after 10 minutes. The top right panel shows the paper immediately after being transferred to the agar plate. The bottom left panel shows the cultured ink after 49 hours of growth. The bottom right panel shows the cultured ink after 93 hours of growth. Algal cultures below an OD₇₃₀ 1.0 are translucent and therefore difficult to see when applied to agar or paper. In certain exemplary embodiments, a pH indicator, such as phenolphthalein, is added to the algal culture to allow the user to see what they have written or drawn. By way of example, phenolphthalein is a pH indicator that is colorless in acidic and weakly basic solutions below a pH of 8.2 and a pink color above a pH of 8.2. The pH of the algae solution is near neutral/basic and keeps the phenolphthalein pink. When the phenolphthalein/algae solution is applied to paper, it remains pink until placed onto the agar media in the growth chamber. The agar media is buffered to a pH of 8.0 and moves the pH of the phenolphthalein below 8.2. The shift in pH turns the phenolphthalein colorless, which allows the algae message to appear to grow out of a blank piece of paper. Similarly, the phenolphthalein/algae solution can be applied directly to agar. In further embodiments, other pH indicators such as thymolphthalein, cresolphthalein and the like can be used.

As is shown in FIG. 3B, immediately after application on dry paper, the ink is “visible” to the user, and then “disappears” upon transfer to the BG-11 Agar, only to “reappear” later as the message is developed. In an exemplary embodiment, 0.75 ml of a solution of phenolphthalein in alcohol (0.1 g phenolphthalein in 10 ml ethanol, which is then further diluted to 100 ml with water) is added to each of the diluted algae solutions in equal parts to generate a 50/50% solution of algal solution/phenolphthalein solution. The addition of the phenolphthalein solution makes the original cell solution of OD₇₃₀ of 2.0 a final cell concentration of OD₇₃₀ of 1.0, while the original cell solution of OD₇₃₀ of 0.2 a final cell concentration of OD₇₃₀ of 0.1, and so on with the lower cell concentrations. Upon adding all appropriate solutions, the user then applies the ink to a dry sheet of sterile paper that is untreated with any sizing treatments and has a weight of 300 grams/meter squared.

### Example 2

### Growth on Substrate

Various embodiments of cultured ink can be grown on a variety of substrates. For a paper or paper like application intended for message delivery or development of a greeting card, several components are required. In certain embodiments, a incubation device, such as a growth chamber with a suitable optically clear lid is used for incubation (as is shown for example, in FIG. 8). In these embodiments, the growth chamber allows the algal solutions to receive the required moisture and micronutrients that are essential for their development and continued growth. In certain embodiments, the growth chamber contains an agal/growth solution, which contains an agar concentration of anywhere between 0.5%-4% wt/vol is added while still in the liquid form. In certain exemplary embodiments, approximately 60 ml solution is used, though various other volumes are contemplated by differing applications. In these embodiments, the agar/growth solution is allowed to substantially fill the lower portion of the growth chamber and is subsequently solidified into a gel form. This growth chamber can then be used to support the growth of algal paint solutions that have been applied to a suitable paper or paper like substrate. Once the cultured ink has been applied to the suitable substrate, it is laid directly onto the agar within the growth chamber and is left there for weeks to months so to facilitate growth of the ink.

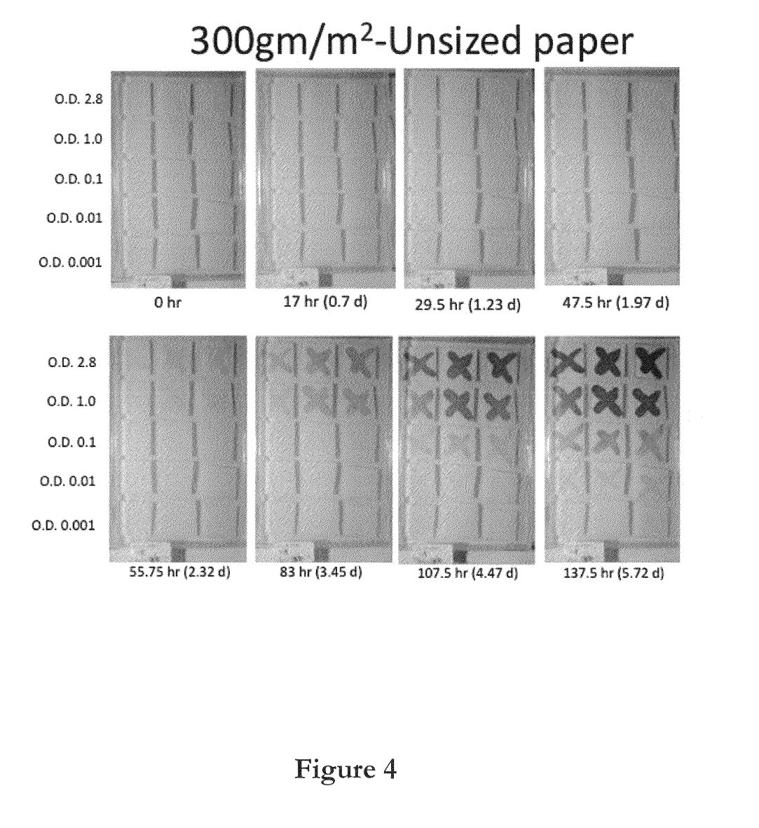

FIG. 4 depicts a single plate of various densities of a Synechocystis algae culture throughout the course of 5+ days of growth. Dilution series of Synechocystis sp. ink brushed on 300 g/m² unsized (untreated) paper laid on a single agar plate illustrates a density dependent growth rate. Each panel represents an image of the same agar plate over the course of the experiment. The density of each ink culture is indicated to the left of each row. The density of the Synechocystis sp. cultured ink was measured with a CARY-UV Spectrophotometer at 730 nm and determined to be at an optical density (OD₇₃₀) of 2.8. The culture was diluted to an OD₇₃₀ of 1.0, 0.1, 0.01, and 0.001. The undiluted and diluted ink cultures were brushed onto rows of swatches of 300 g/m² unsized printmaking paper in biological triplicates. Each swatch had been placed onto agar plate prior to the application of the ink culture. The plate was placed under ˜50 mE of continuous light at room temperature for approximately 5 days. Pictures were taken at various times noted beneath each image.

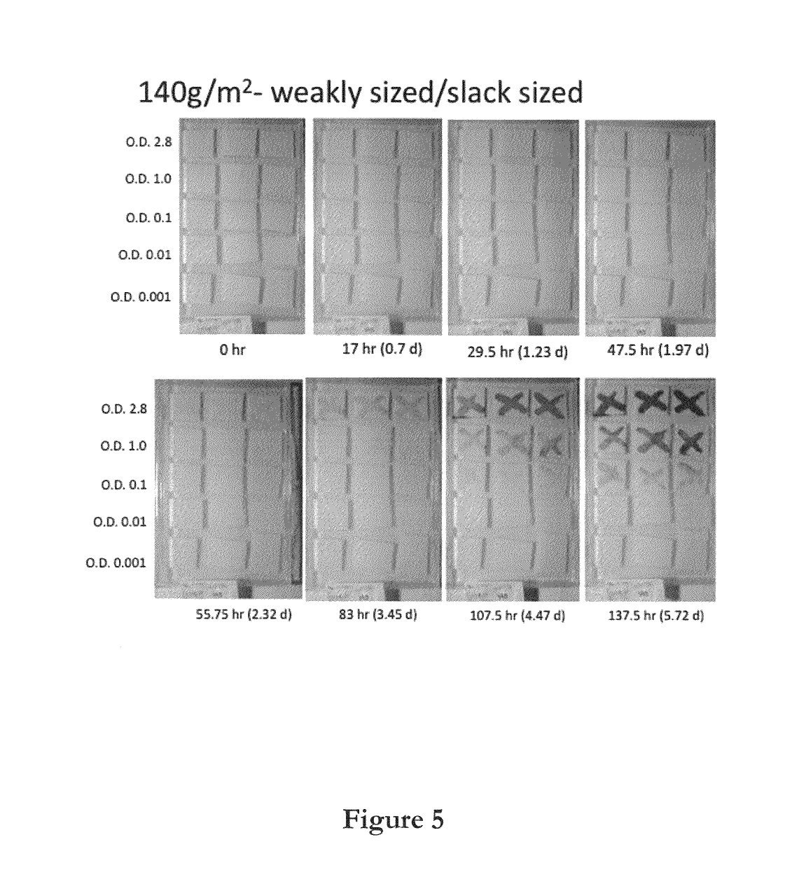

FIG. 5 depicts a single plate of various densities of a Synechocystis algae culture throughout the course of 5+ days of growth. Dilution series of Synechocystis sp. ink brushed onto 140 g/m² slack-sized (weakly treated) paper laid on a single agar plate illustrates a density dependent growth rate. Each panel represents an image of the same agar plate over the course of the experiment. The density of each ink culture is indicated to the left of each row. The density of the Synechocystis sp. cultured ink was measured with a CARY-UV Spectrophotometer at 730 nm and determined to be at an optical density (OD₇₃₀) of 2.8. The culture was diluted to an OD₇₃₀ of 1.0, 0.1, 0.01, and 0.001. The undiluted and diluted ink cultures were brushed onto rows of swatches of 140 g/m² slack-sized printmaking paper in biological triplicates. Each swatch had been placed onto agar plate prior to the application of the ink culture. The plate was placed under ˜50 mE of continuous light at room temperature for approximately 5 days. Pictures were taken at various times noted beneath each image.

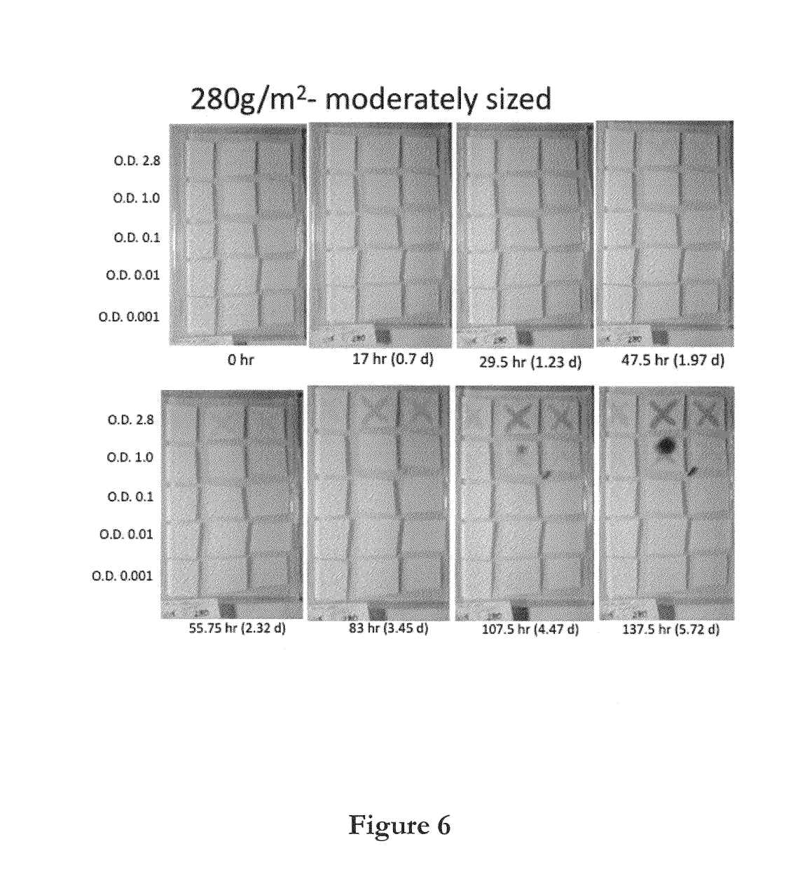

FIG. 6 depicts a single plate of various densities of a Synechocystis algae culture throughout the course of 5+ days of growth. Depicted is a dilution series of Synechocystis sp. cultured ink brushed on 280 g/m² moderately sized (treated) paper laid on a single agar plate illustrates a density dependent growth rate. Each panel represents an image of the same agar plate over the course of the experiment. The density of each ink culture is indicated to the left of each row. The density of a Synechocystis sp. ink culture was measured with a CARY-UV Spectrophotometer at 730 nm and determined to be at an optical density (OD₇₃₀) of 2.8. The culture was diluted to an OD₇₃₀ of 1.0, 0.1, 0.01, and 0.001. The undiluted and diluted ink cultures were brushed onto rows of swatches of 280 g/m² moderately sized printmaking paper in biological triplicates. Each swatch had been placed onto agar plate prior to the application of the ink culture. The plate was placed under ˜50 mE of continuous light at room temperature for approximately 5 days. Pictures were taken at various times noted beneath each image.

### Example 3

### Application of Algae

In exemplary embodiments, placement of the substrate or paper material onto the growth solution as described herein allows for nutrients and other elements essential for the growth of the microorganisms to diffuse through the paper and become available for the cultured ink placed on the top surface of the paper or substrate. In these embodiments the entire case is then placed in a location that receives light radiation within the visible range of light, such as between 400 nm and 700 nm wavelengths, which includes sunlight and is within the temperature range of 60 degrees Feirenheit and 95 degrees Feirenheit. As described herein in relation to FIGS. 7A-7C, the cultured ink is applied to the substrate such as paper stock using the applicator or other application method.

Table 3 is a description of the time (in days) in which specific density populations of Synechocystis sp. PCC 6803 will grow into a visible form directly on the selected growth media in the presence of 24 hour continuous light conditions. Using this information, the cultured ink can be configured to “appear” after a specific interval, and multiple inks may be used to produce an image which is phasic in appearance.

TABLE 3
GROWTH DAYS REQUIRED FOR VISABLE APPEARANCE

| | Growth days required for visible |
|---|---|
| Density of algal solution | appearance (24 hours light) |
| (OD₇₃₀ nm wavelength) | Synechocystis sp. PCC 6803 |
| 10 | 1 |
| 2.5 | 2 |
| 1 | 3 |
| 0.1 | 4 |
| 0.01 | 5 |

As such, in certain aspects, by using a plurality of applicators and/or cultured inks containing different concentrations or types of microbes, and applying those inks accordingly on different areas of the substrate, a user can create an image—such as a message—that becomes visible over the course of several hours or days, as is shown in FIG. 2. For example, and as described in Table 3, a cell concentration of the cyanobacterial species Synechocystis sp. PCC 6803 of a measured optical density of 10 at an absorbance of 730 nm wavelength of light (equates to 6.1×10⁸ cells/ml solution) grows to an observable image in 1 day or less under 24 hour lighting conditions and around 2 days under nominal daylight conditions (10 hours light/14 hours dark), while a 10 times diluted population with a measured OD₇₃₀ of 1.0, which equates to approximately 8.5×10⁷ cells/ml solution in certain embodiments, grows to an observable image in around 3 days under 24 hour lighting conditions and around 5 days under nominal daylight conditions. Additionally, a population of cells with a 100 times dilution with a measured optical density of 1.0 at an absorbance of 730 nm wavelength of light (equates to 1.0×10⁷ cells/ml solution) grows to an observable image in about 11 days under 24 hour lighting conditions, while under nominal daylight conditions grows to an observable image in around 15 days. Modulation of the densities of the populations used as cultured ink on the paper substrate allows the user to send messages that develop and change over time, thus giving the message a time lapse effect. By way of example, a user may use applicators containing differing concentrations of cultured ink to create a message on the substrate, wherein a first aspect of the message becomes visable earlier, and a second aspect becomes visable later.

Accordingly, over several days to weeks depending on conditions, the independent microbial populations will grow within the locations of which they are placed on the paper substrate by the methods and systems described herein. In these embodiments, the cultured ink or inks will continue to grow within these constrained regions, and it has been observed that they become raised above the surface of the paper until the moisture from the growth solution evaporates entirely, thereby leaving the agar polymer and trace nutrients and elements. At this point in time the algal populations become “fixed” to the surface of the paper substrate and remain there as semi-permanent “ink” as a keepsake for the user.

Varying the concentrations of the microbes allows for a time lapse effect to occur directly on the growth media. For example, a cell concentration of Synechocystis of a measured OD₇₃₀, which equates to approximately a 6.1×10⁸ cells/ml solution, grows to an observable image in 0.5-1 days under nominal ambient sunlight conditions, while an OD₇₃₀ of 1.0 at an absorbance of 730 nm wavelength of light (equates to 8.5×10⁷ cells/ml solution) grows to an observable image in 1-2 days. Additionally, a population of cells with a 100 times dilution with a measured optical density of 1.0 at an absorbance of 730 nm wavelength of light (equates to 1.0×10⁷ cells/ml solution) grows to an observable image in 5-6 days, a population of cells with a 1000 times dilution with a measured optical density of 0.1 at an absorbance of 730 nm wavelength of light (equates to 4.0×10⁶ cells/ml solution) grows to an observable image in 6-8 days. Modulation of the densities of the populations used as ink on the Growth Media allows the user to paint images resembling stained glass that develop and change over time.

Table 4 is a description of the time (in days) in which specific density populations of Synechocystis sp. PCC 6803 and Synechococcus sp. PCC 7002 will grow into a visible form on a paper substrate in the presence of 10 hours nominal daylight conditions and 24 hour continuous light conditions.

TABLE 4
GROWTH DAYS FOR 10 & 24 HOUR LIGHT EXPOSURES IN
SYNECHOCYSTIS SP. PCC 6803 & SYNECHOCYSTIS SP. PCC 7002

| | Growth Days | Growth Days | Growth Days | Growth Days |
|---|---|---|---|---|
| | Required For | Required For | Required For | Required For |
| Density Of | Visible | Visible | Visible | Visible |
| Algal | Appearance | Appearance | Appearance | Appearance |
| Solution | (10 Hours Light) | (24 Hours Light) | (10 Hours Light) | (24 Hours Light) |
| (OD₇₃₀ nm | Synechocystis | Synechocystis | Synechococcus | Synechococcus |
| Wavelength) | Sp. PCC 6803 | Sp. PCC 6803 | Sp. PCC 7002 | Sp. PCC 7002 |
| 10 | 2 | 1 | 1 | 0.5 |
| 1 | 5 | 3 | 2 | 1 |
| 0.1 | 15 | 11 | 5 | 3 |
| 0.01 | 24 | 18 | 9 | 6 |

In an exemplary embodiment of the cultured ink, system, apparatus and methods, a cyanobacterial culture of Synechocystis species was cultivated in specific growth media BG-11/TES under artificial light of 100 uE light at room temperature (65 degree Fahrenheit to 90 degrees Fahrenheit) until the optical density of 730 nm wavelength of light measured (OD₇₃₀) reached a value of 10.0. The cells were pelleted in 50 mL tubes at 5000×g using a centrifuge. The cells are re-suspended in 1 mL thus the original algae culture is concentrated by 50× the original concentration, thus making them an OD₇₃₀ of 500.0. A portion of this algae concentrate is kept aside for direct use while the remainder of the cells are re-suspended via serial dilutions in the BG-11 growth media to obtain vials that contain final volumes of 1 ml at cellular concentrations of OD₇₃₀ of 2.0, 0.2, 0.02. 0.75 ml of the algal solutions are then loaded into individual 1.5 ml plastic tubular shaped reservoirs with a single open threaded end that are labeled appropriately.

Into the open end, a plastic or natural sponge material with spaces between cells measuring between 5-100 micrometers in diameter and formed as a molded chisel tip is wedged into the open end of the tubular shaped reservoir. A plastic cylindrical collar that is open at both ends is then placed over the sponge tip and is threaded onto the threads of the tubular shaped reservoir, so that the chisel tip is extruding from the un-threaded end. The end that is opposite to the threads on the collar has a smaller open diameter than the threaded end, so as to confine the sponge chisel tip. Use of the sponge allows for the solution to be present on the surface of the sponge tip, while not become so profuse on the surface as to cause drops of solution to form on the sponge. Further, capillary action of the algal solution keeps the writing tip of the foam pen assembly constantly wet during use, but at the same time, not so profuse to be dripping liquid onto unintended regions of the paper.

The ink solutions are used in a manner that allows for specific parts of a message to appear at varying rates. The highest concentration of cells, the undiluted OD₇₃₀ of 500 solution is directly visible on the paper as it is applied. The writing done with this solution will continue to grow and darken with time, but will always be visible immediately as it is applied. The user then applies the cell solution with an OD₇₃₀ of 1.0 as ink for separate parts of the image or message to be completed.

### Application Methods

Many application methods are available for applying the algae solution to the appropriate substrate for growth.

FIGS. 7A-7C are an illustration of various embodiments of an applicator and the constituent parts. In exemplary embodiments, the applicator 10 comprising a substantially hollow elongate tubular body 11 having and having first, open end 12 and second, closed end 14. In these embodiments, the body 11 is accordingly configured to house and apply the ink by way of an applicator tip 16, such as a plastic fiber brush 16A or sponge 16B which is disposed at the first end 12 and secured in place by way of a collar 18, which may be used to couple with the body by way of a threaded portion 19, so as to allow the user to re-fill the applicator by removing and replacing the applicator tip. In certain embodiments, a variety of other components may be used for the applicator tip 16, as would be apparent to one of skill in the art.

In further exemplary embodiments, other applicators, such as a paint brush, may be used for application of the cells to the appropriate substrate. In certain embodiments, the paint brush is best used by writing or drawing with short strokes before returning the brush to the reservoir for more microbial paint. It has been determined that drawing with the paint brush for extended periods of time without returning the brush to the paint reservoir causes uneven growth of the algae and incomplete algae application on the substrate is more likely the longer the user paints without returning to the reservoir. This is relevant to certain embodiments, depending on the resulting aesthetic effect desired by the user.

By way of example, in certain embodiments, individual 1.5 ml plastic tubular shaped reservoirs 11 with a single open threaded end 12 are utilized. In the open end 12, a plastic or natural sponge material 16B with spaces between cells measuring between 5-20 micrometers in diameter and formed as a molded chisel tip is placed into the open end 12 of the body 11. In these embodiments, a plastic cylindrical collar 18 having a central opening 15 is then placed over the tip and is threaded onto the threads of the tubular shaped reservoir, so that the chisel tip is extruding from the un-threaded end. The end that is opposite to the threads on the collar has a smaller open diameter than the threaded end, so as to confine the sponge chisel tip. Use of the sponge allows for the solution to be present on the surface of the sponge tip, while not become so profuse on the surface as to cause drops of solution to form on the sponge. Capillary action of the algal solution keeps the writing tip of foam pen assembly constantly wet during use, as is known in the art.

In an alternative embodiment, a group of thin plastic fibers (as is shown at 16A) can be bunched together with one end of the bunched plastic fibers terminating at a common length and bound together with a perpendicular fiber running the diameter of the bundled fibers. This end is inserted into the open end of the tubular shaped reservoir. The opposite end of the bunched plastic fibers is cut so that the end of the fibers forms a fine tip that is flexible. The gaps between the fibers are large enough (larger than 0.75 microns) to allow the algae solution to wick down to the end of the tip. To dispense the microbes, such as algae onto the appropriate substrate, light pressure is applied on the tubular reservoir until the algal solution becomes visible within the sponge or at the end of the plastic fiber tip. The algal solution can then be placed on the appropriate substrate by gently applying the sponge tip directly onto the substrate while applying a small amount of pressure to the tubular body of the reservoir. This pressure ensures that the cultured ink is being forced onto and through the sponge body to the surface of the sponge.

Cultured ink may also be printed on any and all types of substrates discussed by using a modified inkjet printer, 3D printer or other established printing methods known in the art.

In certain embodiments, the disclosed system and methods comprise a growth chamber, or media frame, which can also be referred to as a “pad” 20. FIGS. 8A-B depict an exemplary embodiment of a paper-based drawing pad 20. In certain embodiments, the drawing pad 20 comprises a base 22 and lid 24. In further embodiments, the lid 24 is pivotally attached to the base 22 by way of a hinge 26 so as to take a clamshell configuration. Other embodiments are possible. In certain embodiments, liquid agar-based growth media 28 is poured and cooled in the base 22 of the drawing pad. Once the growth media is cooled and solidified, a paper or paper like substrate 30 is laid directly on the top of the cooled growth media 28. The user then utilizes an applicator to paint various concentrations of photosynthetic microbes onto the paper or paper-like substrate 30. Over time, the images become apparent to reveal the image, writing or other communication placed on the substrate, as is depicted for example in FIG. 2. Once the image, writing or other communication has grown and all moisture has evaporated from the growth media, the user then removes the paper and can deliver card to the appropriate recipient.

FIG. 8B is an illustration of the top view of the paper based drawing pad. Liquid agar based growth media is poured and cooled in the drawing pad 20. Once the growth media is cooled and solidified, a paper or paper like substrate is laid directly on the top of the cooled growth media. The user then utilizes the described algal pen delivery system to paint various concentrations of photosynthetic microbes onto the paper or paper-like substrate. Over time, the images become apparent to reveal the image, writing or other communication placed on the substrate. Once the image, writing or other communication has grown and all moisture has evaporated from the growth media, the user then removes the paper and can deliver card to the appropriate recipient.

To ensure the future growth of the algae on the paper, in certain embodiments the base 22 and/or lid 24 may comprise a rigid plastic box with the dimensions that are as large or larger than the drawing paper and is of very similar shape as the paper with a suitable optically clear lid 24. The base 22 is then filled with approximately 60 ml of agar/BG-11 growth solution, which contains an agar concentration of 1.0% wt/vol, has a final concentration of TES buffer of 10 mM, and has a final concentration of sodium thiosulfate of 20 mM. This solution is added while still in the liquid form. The agar/BG-11 Growth Solution is allowed to completely fill the base 22 and subsequently solidifies into a gel form.

Once the drawing is complete, the user then lays the drawing, face side up, onto the pre-poured agar/growth solution plate. Once the paper is deposited on to the gelatinous material, the clear top cover of the agar plate is closed and the entire box is placed under a desk lamp with sufficient light production (>50 uE light) and left to grow. As the paper is laid onto the agar/growth solution, the phenolphthalein solution that has allowed the diluted cell solutions to be visible now disappears. Therefore, the image or message drawn with the diluted cell solutions can no longer be seen until the algal cells that make up the “ink” grow to a concentration that is visible to the naked human eye. The user then can remove the paper from the agar/growth solution once they feel that their message is fully-grown. The paper is then placed directly on top of the plastic box and left to dry for 12-24 hours.

FIGS. 9A-B depict a further embodiment of the drawing pad 40. In this embodiment, the pad 40 comprises a base 42 and lid 44, and a prop 50, such as a kickstand. In these embodiments, a reservoir 52 is utilized to supply a mixture of nutrients/water to the substrate 60, by way of capillary action.

Although the disclosure has been described with reference to preferred embodiments, persons skilled in the art will recognize that changes may be made in form and detail without departing from the spirit and scope of the disclosed apparatus, systems and methods.

What is claimed is:

1. An ink comprising:
a. a plurality of microbes;
b. a liquid growth media; and
c. a transiently visible compound.

2. The ink of claim 1, wherein the plurality of microbes is selected from a group consisting of Synechocystis sp. PCC 6803, Synechococcus sp. PCC 7002, and Haematococcus pluvialis.

3. The ink of claim 1, wherein the plurality of microbes are present at an OD₇₃₀ of from about 0.01 to about 1000 OD.

4. The ink of claim 1, wherein the liquid growth media is TES, BICINE, or HEPES.

5. The ink of claim 1, further comprising a carbon source selected from a group consisting of sucrose, fructose, glucose, galactose, amino acids, proteins, fats, oils lipids, and carbohydrates.

6. The ink of claim 1, wherein the transiently visible compound is visible at pH of 8.2 and above and invisible at pH below 8.2.

7. The ink of claim 6, wherein the transiently visible compound is phenolphthalein, thymolphthalein or cresolphthalein.

8. The ink of claim 1, wherein the transiently visible compound is selected from a group consisting of ammonia, copper sulfate, lead nitrate, iron sulfate, cobalt chloride, iron sulfide, starch, lemon juice, sodium chloride, and cerium oxalate.

9. A method of printing with cultured ink comprising:
a. providing a ink solution comprising a plurality of microbes;
b. applying the ink solution to a substrate; and
c. providing light and liquid growth media to the substrate so as to develop the ink solution on the substrate over time.

10. The method of claim 9, wherein the substrate is paper.

11. The method of claim 9, wherein the substrate is applied to a secondary substrate prior to the application of the ink.

12. The method of claim 9, wherein the ink is applied to the substrate by way of an applicator.

13. The method of claim 12 wherein the applicator is selected from the group consisting of a pen, a brush, a printer, and a stylus.

14. A kit for printing with cultured ink comprising:
a. cultured ink components further comprising:
i. a plurality of microbes; and
ii. a growth media;
b. a growth media frame; and
c. an applicator.

15. The kit of claim 14, further comprising a transiently visible compound.

16. The kit of claim 14, further comprising a carbon source.

17. The kit of claim 14, further comprising a substrate.

18. The kit of claim 14, further comprising a secondary substrate.

19. The kit of claim 14, wherein the growth media frame further comprises a reservoir and a substantially translucent lid.

20. The kit of claim 14, further comprising cultured ink components for a plurality of cultured inks.
